(19) United States
(12) Patent Application Publication
(10) Pub. No.: US 2025/0336584 A1
(43) Pub. Date: Oct. 30, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Keisuke KUNIMORI, Nagaokakyo-shi (JP); Katsufumi SASAKI, Nagaokakyo-shi (JP)

(73) Assignee: Murata Manufacturing Co., Ltd., Kyoto-fu (JP)

(21) Appl. No.: 19/084,472

(22) Filed: Mar. 19, 2025

(30) Foreign Application Priority Data
Apr. 25, 2024 (JP) 2024-071780

(51) Int. Cl. H01F 5/04; H01F 3/02; H01F 5/06; H01F 27/28; H01F 37/00

(52) U.S. Cl. CPC H01F 5/04; H01F 3/02; H01F 5/06; H01F 27/2885; H01F 37/00

(57) ABSTRACT

An inductor component includes a first inductor wire that extends around a first axis extending in a first direction, and an element in which the first inductor wire is located. The element includes a magnetic member that is spaced farther from the first axis than the first inductor wire in a second direction that crosses the first direction, and a first protective film that is spaced farther from the first axis than the magnetic member in the second direction, and that is in contact with the magnetic member in the second direction. The first protective film has a thickness, serving as a dimension in the first direction, greater than the thickness of the first inductor wire.

### CROSS-REFERENCE TO RELATED APPLICATION

This application claims benefit of priority to Japanese Patent Application No. 2024-071780, filed Apr. 25, 2024, the entire content of which is incorporated herein by reference.

### BACKGROUND

### Technical Field

The present invention relates to an inductor component.

### Background Art

Japanese Unexamined Patent Application Publication No. 2023-148899 discloses a coil component that includes an element containing a magnetic member and an insulating layer disposed at a bottom surface of the element.

### SUMMARY

The coil component disclosed in Japanese Unexamined Patent Application Publication No. 2023-148899 has room for improvement in reducing the deterioration of the magnetic member due to, for example, the environmental load.

The present disclosure aims to provide an inductor component that can reduce the deterioration of the magnetic member.

An inductor component according to an aspect of the present disclosure includes a first inductor wire that extends around a first axis extending in a first direction; and an element in which the first inductor wire is located. The element includes a magnetic member that is spaced farther from the first axis than the first inductor wire in a second direction that crosses the first direction, and a first protective film that is spaced farther from the first axis than the magnetic member in the second direction, and that is in contact with the magnetic member in the second direction. The first protective film has a thickness serving as a dimension in the first direction greater than the thickness of the first inductor wire. The inductor component of the above aspect can reduce the deterioration of a magnetic member.

### BRIEF DESCRIPTION OF THE DRAWINGS

FIG. 1 is a perspective view of an inductor component according to an aspect of the present disclosure;

FIG. 2 is a plan view of the inductor component illustrated in FIG. 1;

FIG. 3 is a cross-sectional view of the inductor component taken along line III-III in FIG. 2;

FIG. 4 is a schematic plan view of a layer of a first inductor wire of the inductor component illustrated in FIG. 1;

FIG. 5 is a schematic plan view of a layer of a second inductor wire of the inductor component illustrated in FIG. 1;

FIG. 6 is a first diagram illustrating an example of a method for manufacturing the inductor component illustrated in FIG. 1;

FIG. 7 is a second diagram illustrating an example of a method for manufacturing the inductor component illustrated in FIG. 1;

FIG. 8 is a third diagram illustrating an example of a method for manufacturing the inductor component illustrated in FIG. 1;

FIG. 9 is a fourth diagram illustrating an example of a method for manufacturing the inductor component illustrated in FIG. 1;

FIG. 10 is a fifth diagram illustrating an example of a method for manufacturing the inductor component illustrated in FIG. 1;

FIG. 11 is a sixth diagram illustrating an example of a method for manufacturing the inductor component illustrated in FIG. 1;

FIG. 12 is a seventh diagram illustrating an example of a method for manufacturing the inductor component illustrated in FIG. 1;

FIG. 13 is an eighth diagram illustrating an example of a method for manufacturing the inductor component illustrated in FIG. 1;

FIG. 14 is a ninth diagram illustrating an example of a method for manufacturing the inductor component illustrated in FIG. 1;

FIG. 15 is a tenth diagram illustrating an example of a method for manufacturing the inductor component illustrated in FIG. 1;

FIG. 16 is a schematic plan view of a first modification example of the inductor component illustrated in FIG. 1;

FIG. 17 is a schematic plan view of a second modification example of the inductor component illustrated in FIG. 1;

FIG. 18 is a schematic plan view of a third modification example of the inductor component illustrated in FIG. 1;

FIG. 19 is a perspective view of a fourth modification example of the inductor component illustrated in FIG. 1;

FIG. 20 is an enlarged side view of a fifth modification example of the inductor component illustrated in FIG. 1;

FIG. 21 is a perspective view of a sixth modification example of the inductor component illustrated in FIG. 1; and

FIG. 22 is a perspective view of a seventh modification example of the inductor component illustrated in FIG. 1.

### DETAILED DESCRIPTION

Various aspects of the present disclosure are described.

An inductor component according to a first aspect, comprising a first inductor wire that extends around a first axis extending in a first direction; and an element in which the first inductor wire is located. The element includes a magnetic member that is spaced farther from the first axis than the first inductor wire in a second direction that crosses the first direction, and a first protective film that is spaced farther from the first axis than the magnetic member in the second direction, and that is in contact with the magnetic member in the second direction. The first protective film has a thickness, serving as a dimension in the first direction, greater than the thickness of the first inductor wire.

An inductor component according to a second aspect, dependent on the inductor component according to the first aspect, comprising a first conductor layer located on a first virtual plane that crosses the first direction. The first inductor wire is disposed on the first conductor layer. The first conductor layer includes a first body located around the first axis, and an extended portion extending from the first body in the second direction away from the first axis or in the second direction toward the first axis.

An inductor component according to a third aspect, dependent on the inductor component according to the second aspect, comprising a second conductor layer located on a second virtual plane parallel to and adjacent to the first virtual plane; and a second inductor wire disposed on the second conductor layer, located on an opposite side of the second conductor layer from the first conductor layer in the first direction, and extending around a second axis extending in the first direction.

An inductor component according to a fourth aspect, dependent on the inductor component according to the second aspect or the third aspect, wherein the first protective film covers the first conductor layer.

An inductor component according to a fifth aspect, dependent on the inductor component according to any one of the first aspect to the fourth aspect, wherein the first protective film includes a plurality of materials, and the plurality of materials include at least an inorganic filler.

An inductor component according to a sixth aspect, dependent on the inductor component according to any one of the first aspect to the fifth aspect, wherein the first protective film includes a plurality of materials, and all the plurality of materials are photosensitive materials.

An inductor component according to a seventh aspect, dependent on the inductor component according to the third aspect, comprising a first insulating layer disposed in the element, and located between the first inductor wire and the second conductor layer, wherein the first protective film and the first insulating layer are formed into an integrated unit.

An inductor component according to an eighth aspect, dependent on the inductor component according to any one of the first aspect to the seventh aspect, wherein the element has a structure in which the magnetic member is in contact with an end portion of the first protective film in the first direction.

An inductor component according to a ninth aspect, dependent on the inductor component according to any one of the first aspect to the eighth aspect, wherein the magnetic member has a rectangular shape having a chamfered corner when viewed in the first direction. Also, when a dimension in a direction in which a distance from an outer surface of the first protective film to the magnetic member is minimum when viewed in the first direction is defined as a width, the width of the first protective film is greatest at the chamfered corner.

An inductor component according to a tenth aspect, dependent on the inductor component according to the fourth aspect, wherein a portion of the first conductor layer that is in contact with the first protective film is spaced apart from the first inductor wire.

An inductor component according to an eleventh aspect, dependent on the inductor component according to the second aspect or the third aspect, comprising a third conductor layer located on the first virtual plane; a third inductor wire disposed at the third conductor layer, spaced apart from the first axis in the second direction, and located around a third axis extending in the first direction; and a second insulating layer located between the first inductor wire and the third inductor wire in the second direction. The first protective film and the second insulating layer are formed into an integrated unit.

An inductor component according to an twelfth aspect, dependent on the inductor component according to the second aspect or the third aspect, wherein the extended portion extends from the first body in the second direction away from the first axis, and of two end portions of the extended portion in the second direction, a distal end portion located farther from the first body is in contact with the first protective film.

An inductor component according to a thirteenth aspect, dependent on the inductor component according to the twelfth aspect, wherein the first protective film covers an entirety of the distal end portion.

An inductor component according to a fourteenth aspect, dependent on the inductor component according to any one of the first aspect to the thirteenth aspect, comprising a second protective film that is in contact with one of the two end portions of the element in the first direction.

An inductor component according to a fifteenth aspect, dependent on the inductor component according to any one of the first aspect to the fourteenth aspect, wherein the first protective film includes a first film and a second film having a lower ratio of exposure to the outside than the first film.

Embodiments of the present disclosure are described below with reference to the drawings. The description given below is not intended to limit the present disclosure, and is essentially a mere example, and thus may be modified as appropriate within the scope not departing from the gist of the present disclosure. The drawings are schematic, and the dimensional ratios of components may be different from the actual ones. In the description given below, the wording such as “approximately”, “about”, or “substantially” is used to indicate that the value or the shape following such wording includes the tolerable error range determined by persons having ordinary skill in the art.

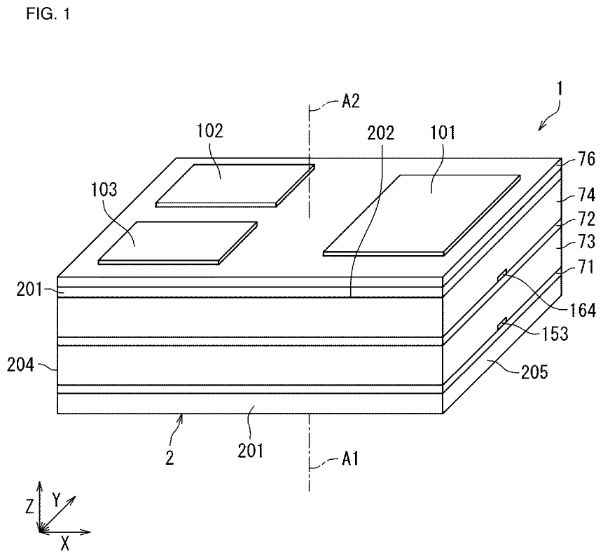

As illustrated in FIG. 1 to FIG. 3, an inductor component 1 of the present disclosure includes a first inductor wire 21 and an element 2. The first inductor wire 21 extends (is located) in the element 2 around a first axis A1 extending in a first direction (for example, a Z-direction). The element 2 includes a magnetic member (magnetic layer) 201 and an insulating layer 73 (an example of a first protective film).

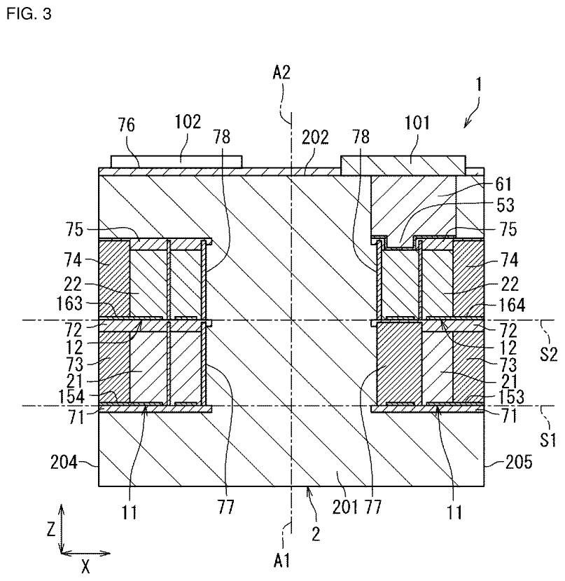

In the present aspect, the inductor component 1 includes a first conductor layer 11, a second conductor layer 12, and a second inductor wire 22 in addition to the first inductor wire 21 and the element 2. The first conductor layer 11, the second conductor layer 12, and the second inductor wire 22 are located inside the element 2. As illustrated in FIG. 3, the first conductor layer 11 is located on a first virtual plane S1. The first inductor wire 21 is disposed on the first conductor layer 11, and extends along the first virtual plane S1. A direction crossing (for example, orthogonal to) the first virtual plane S1 is defined as a first direction Z. For example, the first virtual plane S1 is located at the boundary between an insulating layer 71 and the first conductor layer 11.

As illustrated in FIG. 3, the second conductor layer 12 is located on a second virtual plane S2 parallel to and adjacent to the first virtual plane S1. The state where the second virtual plane S2 is parallel to and adjacent to the first virtual plane S1 indicates a state where the first virtual plane S1 and the second virtual plane S2 are parallel to each other, and the second virtual plane is spaced apart from the first virtual plane S1 in the direction orthogonal to the first virtual plane S1. The first inductor wire 21 is located between the first conductor layer 11 and the second conductor layer 12 in the first direction Z crossing the first virtual plane S1 and the second virtual plane S2. The second inductor wire 22 is disposed at the second conductor layer 12, and extends along the second virtual plane S2. The second inductor wire 22 is located on the opposite side of the second conductor layer 12 from the first inductor wire 21 in the first direction Z, and located around a second axis A2 crossing (for example, orthogonal to) the second virtual plane S2. For example, the first axis A1 and the second axis A2 are aligned with each other (refer to FIG. 3). The second virtual plane S2 is located at the boundary between an insulating layer 72 and the second conductor layer 12.

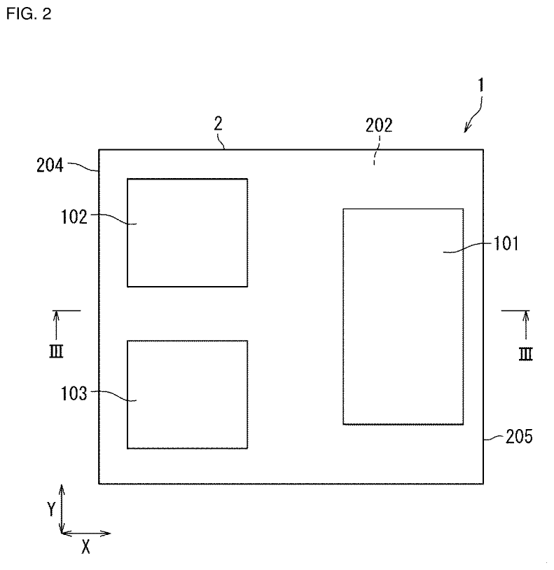

The element 2 has a size of, for example, 1.2×1.04×0.55 mm. As illustrated in FIG. 2 and FIG. 3, the element 2 has an outer surface (hereafter also referred to as a main surface 202) crossing the first direction Z. As illustrated in FIG. 1 and FIG. 2, multiple outer terminals 101 to 103 and an insulating layer 76 (an example of a second protective film) are disposed at the main surface 202. The insulating layer 76 has a thickness of, for example, 10 μm, and is in contact with one of the two end portions of the element 2 in the first direction Z. In the present aspect, the second inductor wire 22 is located closest to the main surface 202 (in other words, the outer terminal 101) in the first direction Z. The outer terminals 101 to 103 are formed from, for example, a Cu/Ni/Au (=5/5/0.1 um) multilayer body.

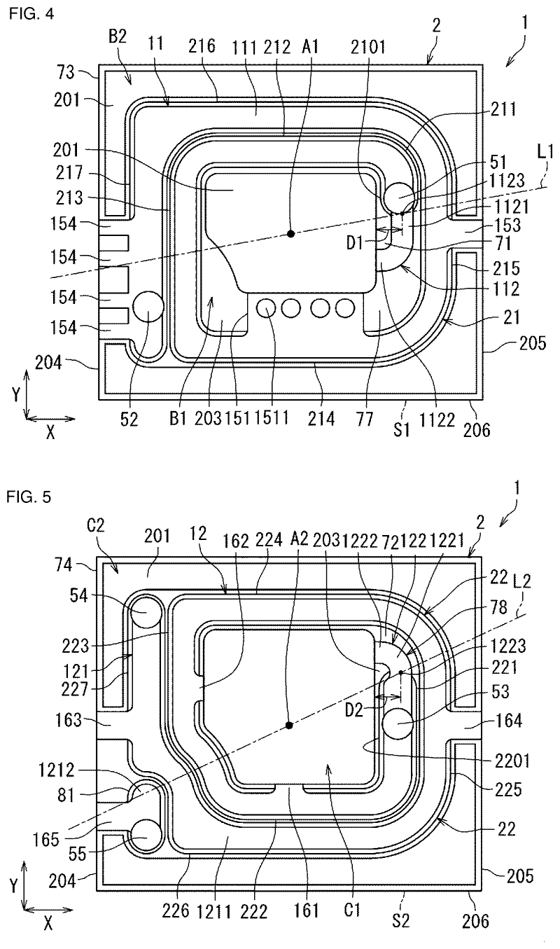

As illustrated in FIG. 4, the element 2 includes, inside, a first area B1 located closer to the first axis A1 than the first inductor wire 21, and a second area B2 located farther from the first axis A1 than the first inductor wire 21. In the first area B1, the magnetic member 201 and a non-magnetic member 203 are located. The magnetic member 201 is located over the entire second area B2. The magnetic member 201 in the second area B2 is spaced farther from the first axis A1 than the first inductor wire 21 in the second direction crossing the first direction Z.

As illustrated in FIG. 4, the insulating layer 73 is spaced farther from the first axis A1 in the second direction than the magnetic member 201 in the second area B2, and is in contact with the magnetic member 201 in the second area B2 in the second direction. The thickness of the insulating layer 73, or the dimension of the insulating layer 73 in the first direction Z is greater than the thickness of the first inductor wire 21. In the present aspect, as illustrated in FIG. 1, the insulating layer 73 has a substantially belt shape extending around the first axis A1, throughout the periphery of the element 2. The insulating layer 73 is disposed to cover the first conductor layer 11 (for example, an extended portion 153) (refer to FIG. 20). In other words, the insulating layer 73 is disposed not to allow the first inductor wire 21 and the first conductor layer 11 to be exposed to the outside of the inductor component 1 in the second direction. As illustrated in FIG. 3, the insulating layer 73 is in contact with, of the two end portions of each of the extended portions 153 and 154 of the first conductor layer 11 in the first direction Z, one end portion located closer to the first inductor wire 21. The extended portions 153 and 154 are described later. For example, the insulating layer 73 extends in the first direction Z from the first virtual plane S1 toward the second virtual plane S2.

The insulating layer 73 may contain multiple materials. More specifically, the insulating layer 73 may be formed from a single material or multiple materials. When the insulating layer 73 is formed from multiple materials, the multiple materials may include at least an inorganic filler, or all the multiple materials may be photosensitive materials.

The state of being in contact with the magnetic member 201 indicates a state of being in contact with at least one of materials forming the magnetic member 201. When the magnetic member 201 is formed from, for example, a composite body of a resin and an inorganic filler (for example, a composite body of epoxy and FeSiCr), a distal end portion of a first body 111 is in contact with at least one of a resin and an inorganic filler in the magnetic member 201. The resin contained in the magnetic member 201 contains, for example, epoxy, acrylic, liquid crystal polymer, phenol, or a combination of two or more of these, to provide the element 2 with strength and preferable insulating properties. The inorganic filler contained in the magnetic member 201 contains, for example, magnetic metal powder (for example, metal containing a Fe element as a main component, such as Fe, FeSi-based material, FeSiCr-based material, or FeNi-based material). The magnetic member 201 in this case has high magnetic permeability and high magnetic saturation density. The inorganic filler may be different from a single type of magnetic powder, but may be magnetic powder including a combination of different compositions or different particle diameters, or may contain an insulating filler such as silica to ensure a coefficient of linear expansion and insulating properties.

A layer of the first inductor wire 21 is located between the first virtual plane S1 and the second virtual plane S2, and a layer of the second inductor wire 22 is located between the second virtual plane S2 and the main surface 202 of the element 2, described later.

As illustrated in FIG. 4, for example, the first inductor wire 21 has a spiral shape when viewed in the first direction Z. The first axis A1 is located at, for example, the center of the profile of the first inductor wire 21. Vias 51 and 52 are respectively connected to both ends of the first inductor wire 21 extending in the direction in which the first inductor wire 21 extends. The first inductor wire 21 is formed from, for example, a L/S/t (=100/10/150 um) multilayer body.

The first inductor wire 21 includes a first portion 211 to a seventh portion 217.

The first portion 211 extends from an end portion located closer to the first axis A1 and to which the via 51 is connected, in a lateral direction Y away from a side surface 206 of the element 2. For example, a portion of the first portion 211 to which the via 51 is connected serves as a first output portion. The side surface 206 is one side surface of a pair of side surfaces of the element 2 extending in a longitudinal direction X.

The second portion 212 extends in the longitudinal direction X from one of the two end portions of the first portion 211 in the lateral direction Y, located farther from the side surface 206 of the element 2.

The third portion 213 extends in the lateral direction Y toward the side surface 206 of the element 2 from one of the two end portions of the second portion 212 in the longitudinal direction X, located farther from the first portion 211.

The fourth portion 214 extends in the longitudinal direction X toward the first portion 211 from one of the two end portions of the third portion 213 in the lateral direction Y, located farther from the second portion 212.

The fifth portion 215 extends in the lateral direction Y away from the side surface 206 of the element 2 from one of the two end portions of the fourth portion 214 in the longitudinal direction X, located farther from the third portion 213. The fifth portion 215 is spaced farther from the first axis A1 than the first portion 211 in the longitudinal direction X, and a part of the fifth portion 215 overlaps the first portion 211 when viewed in the longitudinal direction X from the first axis A1. The fifth portion 215 and the first portion 211 are insulated from each other.

The sixth portion 216 extends in the longitudinal direction X toward the third portion 213 from one of the two end portions of the fifth portion 215 in the lateral direction Y, located farther from the fourth portion 214. The sixth portion 216 is spaced farther from the first axis A1 than the second portion 212 in the lateral direction Y, and a part of the sixth portion 216 overlaps the second portion 212 when viewed in the lateral direction Y from the first axis A1. The sixth portion 216 and the second portion 212 are insulated from each other.

The seventh portion 217 extends in the lateral direction Y toward the side surface 206 of the element 2 from one of the two end portions of the sixth portion 216 in the longitudinal direction X, located farther from the fifth portion 215. The seventh portion 217 is spaced farther from the first axis A1 than the third portion 213 in the longitudinal direction X, and a part of the seventh portion 217 overlaps the third portion 213 when viewed in the longitudinal direction X from the first axis A1. The seventh portion 217 and the third portion 213 are insulated from each other. The via 52 is connected to one of the two end portions of the seventh portion 217 in the lateral direction Y, located closer to the side surface 206 of the element 2. For example, a portion of the seventh portion 217 to which the via 52 is connected serves as a first input portion.

As illustrated in FIG. 4, the first conductor layer 11 includes the first body 111 extending (located) around the first axis A1, and extended portions 151, 153, and 154 extending from the first body 111 in the second direction crossing the first direction away from the first axis A1 or in the second direction toward the first axis A1. In the present aspect, the first conductor layer 11 includes a protrusion 112 disposed at the first body 111. When viewed in the first direction Z, the first body 111 has substantially the same shape as the first inductor wire 21, and the entirety of the first body 111 overlaps the first inductor wire 21. The second direction may be any direction that crosses the first direction, for example, the lateral direction X or the longitudinal direction Y, or may be a direction having components or vectors of both the lateral direction X and the longitudinal direction Y.

In the present aspect, the first conductor layer 11 includes one extended portion 151, one extended portion 153, and four extended portions 154. When the first conductor layer 11 including the multiple extended portions 151, 153, and 154 is formed, a change of direct current resistance of the inductor component 1 can be reduced.

The extended portion 151 extends in the second direction (for example, the lateral direction Y) toward the first axis A1 from a portion of the first body 111 overlapping the fourth portion 214 of the first inductor wire 21 when viewed in the first direction Z. A portion of the first body 111 at which the extended portion 151 is disposed is a portion of the first body 111 facing the first axis A1 in the second direction (for example, the lateral direction Y) and located farthest from the first axis A1. In this structure, when a magnetic path is to be formed around the first axis A1, dissolution of the first inductor wire 21 by etching can be reduced. Thus, an increase of direct current resistance of the inductor component 1 can be reduced.

Of both end portions of the extended portion 151 in the lateral direction Y, the distal end portion farther from the first body 111 is in contact with the magnetic member 201 located in the first area B1, described later.

In the present aspect, the extended portion 151 includes at least one cavity 1511 (for example, four, substantially circular cavities 1511). The cavities 1511 may extend through the extended portion 151 in the first direction Z, but do not have to extend through the extended portion 151. When the cavities 1511 do not extend through the extended portion 151, the cavities 1511 have, for example, a recessed shape set back from one end of the extended portion 151 in the first direction Z toward the other end of the extended portion 151 in the first direction 151. In this case, when the first conductor layer 11 has multiple layers, and the layer of the first conductor layer 11 located farthest from the first inductor wire 21 in the first direction Z is defined as a farthest layer, the farthest layer of the first conductor layer 11 is located between the bottoms of the cavities 1511 and the first virtual plane S1.

The extended portion 151 having at least one cavity 1511 narrows the path through which an etchant accesses the first inductor wire 21, and less easily allows the etchant used to form a magnetic path to reach the first inductor wire 21. This structure reduces an increase and variation of the direct current resistance of the inductor component 1, and thus can enhance the inductance obtaining efficiency of the inductor component 1.

When the cavities 1511 have a recessed shape set back from one end of the extended portion 151 in the first direction Z toward the other end of the extended portion 151 in the first direction Z, a portion of the first extended portion 151 having the cavities 1511 has a smaller thickness than the first body 111. Thus, when, for example, a sacrificial copper portion is to be etched, a portion of the extended portion 151 having the cavities 1511 is opened earlier than the first body 111 to reduce further corrosion by the etchant. This structure can thus reduce an increase and variation of the direct current resistance of the first inductor wire 21. The cavities 1511 with a recessed shape can be formed by, for example, controlling the etching time.

When the cavities 1511 extend through the extended portion 151 in the first direction Z, the path through which an etchant accesses the first inductor wire 21 is interrupted. This structure can thus reduce an increase and variation of the direct current resistance of the first inductor wire 21 caused by the etchant corroding the first inductor wire 21. For example, when the cavities 1511 extend through the extended portion 151, an insulating layer 77 comes into contact with a base (for example, the insulating layer 71) through the cavities 1511, and the extended portion 151 is held between the two insulating layers 71 and 77. Thus, the first conductor layer 11 has sufficient adhesion to the insulating layers 71 and 77.

The first conductor layer 11 includes multiple layers laminated in the first direction Z, and the farthest layer is located between the bottoms of the cavities 1511 and the first virtual plane S1 in the first direction Z, and thus, an optimum metal material to the first conductor layer 11 can be selected. For example, when the first conductor layer 11 is formed from Ti/Cu, Ti enhances the adhesion to the base (for example, the insulating layer 71), and Cu having high electric conductivity can enhance the controllability of the shape of the first inductor wire 21. When the farthest layer is formed only from Ti, the cavities 1511 with high adhesion even with a small thickness can be provided. The farthest layer including multiple layers enables selective etching, and thus can reduce an increase and variation of the direct current resistance of the first inductor wire 21.

The extended portion 151 having the multiple cavities 1511 can reduce the resistance of the first conductor layer 11. In addition, the path through which power is supplied to the first inductor wire 21 is thick and less easily broken, and thus enables stable growth of plating for the first inductor wire 21. Thus, the variation of the first inductor wire 21 can be reduced.

In the present aspect, of both end portions of the extended portion 151 in the first direction Z, the end portion located closer to the first inductor wire 21 is in contact with the insulating layer 77 described later. For example, the cavities 1511 in the extended portion 151 are filled with the insulating layer 77. Thus, the insulating layer 77 and the base (for example, the insulating layer 71) of the first conductor layer 11 are connected through the cavities 1511, and falling or separation of the insulating layer 77 can be reduced.

The extended portion 153 extends in the second direction (for example, the longitudinal direction X) away from the first axis A1 from a portion of the first body 111 overlapping the fifth portion 215 of the first inductor wire 21 when viewed in the first direction Z.

Each extended portion 154 extends in the second direction (for example, the longitudinal direction X) away from the first axis A1, and opposite to the direction in which the extended portion 153 extends, from a portion of the first body 111 overlapping the seventh portion 217 of the first inductor wire 21 when viewed in the first direction Z. The four extended portions 154 are spaced apart from one another at intervals in the Y direction.

Of both end portions of the extended portion 153 in the longitudinal direction X, the distal end portion located farther from the first body 111 is exposed from a side surface 205 of the element 2. Of both end portions of each of the extended portions 154 in the longitudinal direction X, the distal end portion located farther from the first body 111 is exposed from a side surface 204 of the element 2. In this structure, the portions of the extended portions 153 and 154 exposed to the outside of the element 2 may be covered with the insulating layer, and thus the metal corrosion of the extended portions 153 and 154 can be reduced. For example, when the inductor component 1 has a structure in which the distal end portions of the extended portions 153 and 154 are in contact with multiple insulating layers, the distal end portions of the extended portions 153 and 154 can be covered with higher coverage. The side surfaces 204 and 205 extend in the lateral direction Y. The side surface 204 faces the seventh portion 217 of the first inductor wire 21 in the longitudinal direction X, and the side surface 205 faces the fifth portion 215 of the first inductor wire 21 in the longitudinal direction X.

For example, “the width of the extended portion 151”, and “the width of the first inductor wire 21” are defined as below. In this case, the width of the extended portion 151 is greater than the width of the first inductor wire 21. This structure enables reduction of resistance of the first conductor layer 11. In this structure, the path through which power is supplied to the first inductor wire 21 is thick and less easily broken, and thus enables stable growth of plating for the first inductor wire 21. Thus, the variation of the first inductor wire 21 can be reduced. The dimension of the extended portion 151 in the direction (for example, the longitudinal direction X) crossing the direction in which the extended portion 151 extends when viewed in the first direction Z is defined as “the width of the extended portion 151”. The dimension of the first inductor wire 21 in the direction crossing the direction in which the first inductor wire 21 extends is defined as “the width of the first inductor wire 21”.

The protrusion 112 is directed from the first body 111 toward the first axis A1 not by the shortest route but by deviating from the shortest route (or, by a longer route). When viewed in the first direction Z, the protrusion 112 does not extend from the connection portion 1123 connected to the first body 111 toward the end portion of the insulating layer 71 by the shortest distance D1. For example, the end portion of the insulating layer 71 is located at the boundary between the insulating layer 71 and the magnetic member 201 in the first area B1. The protrusion 112 has a dimension in which it extends longer than the shortest distance D1. In the present aspect, the protrusion 112 extends from the first body 111 in the direction crossing the first virtual straight line L1 passing a connection portion 1123 connected to the first body 111 and the first axis A1, and is then directed toward the first axis A1. The protrusion 112 is directed toward the first axis A1 by a longer route instead of the shortest route, and this structure can thus reduce an etchant corroding the first inductor wire 21 when, for example, a magnetic path hole is formed. This structure can thus reduce an increase and variation of the direct current resistance of the inductor component 1. In addition, the protrusion 112 enables power supply using the insulating layer, and thus, the first inductor wire 21 can be formed by plating growth. With the plating growth (for example, electrolytic plating), the first conductor layer 11 with extremely high purity can be formed, and thus, the first inductor wire 21 with high electric conductivity can be formed. Thus, the direct-current electrical resistance of the inductor component 1 can be reduced.

As illustrated in FIG. 4, in the present aspect, the protrusion 112 includes an extension portion 1121 and a bent portion 1122. The extension portion 1121 extends in the lateral direction Y toward the side surface 206 of the element 2 from a portion of the first body 111 overlapping the first portion 211 of the first inductor wire 21 when viewed in the first direction Z. The bent portion 1122 is bent toward the first axis A1 from an end portion, of both end portions of the extension portion 1121 in the lateral direction Y, located closer to the side surface 206 of the element 2. More specifically, the first inductor wire 21 and the protrusion 112 form an angle other than a right angle.

In the present aspect, of both end portions of the protrusion 112 in which the protrusion 112 extends, an end portion located farther from the first body 111 (more specifically, of both end portions of the bent portion 1122 in which the bent portion 1122 extends, an end portion located closer to the first axis A1) is in contact with the magnetic member 201 of the element 2 located in the first area B1. Of both end portions of the protrusion 112 in the first direction Z, the end portion located closer to the first inductor wire 21 is in contact with the insulating layer 77. Of the side surfaces of the first inductor wire 21 crossing the second direction (for example, the longitudinal direction X), the insulating layer 77 is in contact with a first side surface 2101 located closer to the first axis A1 in the second direction (for example, the longitudinal direction X). Thus, the protrusion 112 is protected by the insulating layer 77, and the first inductor wire 21 is prevented from being etched while the magnetic path is formed. This structure can thus reduce lowering of the direct current resistance of the inductor component 1 due to corrosion. The magnetic path thus formed is filled with the magnetic member 201, and thus the inductance obtaining efficiency of the inductor component 1 can be improved. The first body 111 and the protrusion 112 may be formed from the same component or different components.

In the present aspect, the first area B1 is surrounded by the first portion 211 to the fifth portion 215 of the first inductor wire 21 when viewed in the first direction Z. The magnetic member 201 in the first area B1 has a substantially rectangular shape when viewed in the first direction Z, and is adjacent to overlapping portions of the first inductor wire 21 (in the present aspect, the first portion 211 to the third portion 213) when viewed in the second direction from the first axis A1. In other words, when viewed in the second direction from the first axis A1, the magnetic member 201 is adjacent to a portion having a largest number of portions of the first inductor wires 21. The non-magnetic member 203 in the first area B1 is located between a portion where portions of the first inductor wire 21 do not overlap each other (in the present aspect, the fourth portion 214 and the fifth portion 215) and the magnetic member 201 in the first area B1 when viewed in the second direction from the first axis A1. The non-magnetic member 203 includes the insulating layer 77, and extends along the third portion 213, the fourth portion 214, and the fifth portion 215 when viewed in the first direction Z.

As illustrated in FIG. 5, the second inductor wire 22 extends (is located) around the second axis A2 extending in the first direction Z. In the present aspect, the second inductor wire 22 has a spiral shape turning in the opposite direction to that of the first inductor wire 21 when viewed in the first direction Z. The second axis A2 is located at, for example, the center of the contour of the second inductor wire 22. The second inductor wire 22 is formed from, for example, a L/S/t (=100/10/150 um) multilayer body. To both end portions of the second inductor wire 22 in the direction in which the second inductor wire 22 extends, vias 53 and 54 extending in the first direction Z are connected. As illustrated in FIG. 3, the via 53 connects the second inductor wire 22 and a vertical wire 61. The vertical wire 61 connects the second inductor wire 22 and the outer terminal 101 through the via 53. An insulating layer 75 is located between the second inductor wire 22 and the vertical wire 61 in the first direction Z. The insulating layer 75 has a thickness of, for example, 15 μm.

The second inductor wire 22 includes a first portion 221 to a seventh portion 227.

The first portion 221 extends in the lateral direction Y toward the side surface 206 of the element 2 from the end portion to which the via 53 is connected and located closer to the first axis A1. For example, a portion of the first portion 221 to which the via 53 is connected serves as a second output portion. When viewed in the first direction Z, the via 51 and the via 53 are adjacent to each other. The via 51 connects a portion of the first inductor wire 21 to which the via 51 is connected, and a portion of the second inductor wire 22 to which the via 53 is connected. More specifically, the first output portion and the second output portion are adjacent to each other. The state where “the first output portion and the second output portion are adjacent to each other” means, for example, the state where the via 51 and the via 53 are located in an extremely narrow area (for example, within 20 μm) when viewed in the first direction Z. In the present aspect, the via 51 and the via 53 are located within a distance of approximately 10 μm when viewed in the first direction Z.

The second portion 222 extends in the longitudinal direction X from an end portion, of both end portions of the first portion 221 in the lateral direction Y, located closer to the side surface 206 of the element 2.

The third portion 223 extends in the lateral direction Y away from the side surface 206 of the element 2 from an end portion, of both end portions of the second portion 222 in the longitudinal direction X, located farther from the first portion 221.

The fourth portion 224 extends in the longitudinal direction X toward the first portion 221 from an end portion, of both end portions of the third portion 223 in the lateral direction Y, located farther from the second portion 222.

The fifth portion 225 extends in the lateral direction Y toward the side surface 206 of the element 2 from an end portion, of both end portions of the fourth portion 224 in the longitudinal direction X, located farther from the third portion 223. The fifth portion 225 is located farther from the second axis A2 than the first portion 221 in the longitudinal direction X, and a part of the fifth portion 225 overlaps the first portion 221 when viewed in the longitudinal direction X from the second axis A2. The fifth portion 225 and the first portion 221 are insulated from each other.

The sixth portion 226 extends in the longitudinal direction X toward the third portion 223 from an end portion, of both end portions of the fifth portion 225 in the lateral direction Y, located farther from the fourth portion 224. The sixth portion 226 is located farther from the second axis A2 than the second portion 222 in the lateral direction Y, and a part of the sixth portion 226 overlaps the second portion 222 when viewed in the lateral direction Y from the second axis A2. The sixth portion 226 and the second portion 222 are insulated from each other.

The seventh portion 227 extends in the lateral direction Y away from the side surface 206 of the element 2 from an end portion, of both end portions of the sixth portion 226 in the longitudinal direction X, located farther from the fifth portion 225. The seventh portion 227 is located farther from the second axis A2 than the third portion 223 in the longitudinal direction X, and a part of the seventh portion 227 overlaps the third portion 223 when viewed in the longitudinal direction X from the second axis A2. The seventh portion 227 and the third portion 223 are insulated from each other. The via 54 is connected to an end portion, of both end portions of the seventh portion 227 in the lateral direction Y, located farther from the side surface 206 of the element 2. For example, a portion of the seventh portion 227 to which the via 54 is connected serves as a second input portion. As illustrated in FIG. 4 and FIG. 5, the via 52 and the via 54 are spaced apart from each other in the lateral direction Y when viewed in the first direction Z. More specifically, the first input portion and the second input portion are spaced apart in the second direction (for example, the lateral direction Y). When viewed in the first direction Z, the via 52 and the via 54 are spaced apart from each other by a distance of longer than or equal to 200 μm (for example, 500 μm), and thus the first input portion and the second input portion can be separated. Thus, the input portions of the first inductor wire 21 and the second inductor wire 22 are separated, whereas the output portions thereof are used in common, and thus the first inductor wire 21 and the second inductor wire 22 are applicable to a multiphase DC-DC converter. The output portions are used in common, and thus, the first inductor wire 21 and the second inductor wire 22 have the same potential, and thus the inductor component 1 can enhance the resistance to static electricity.

As illustrated in FIG. 5, the second conductor layer 12 includes a second body 121 extending (located) around the second axis A2, and a protrusion 122 disposed at the second body 121. The second body 121 includes a circled portion 1211 having substantially the same shape as the second inductor wire 22 when viewed in the first direction Z, and a non-circled portion 1212 adjacent to the circled portion 1211 while being electrically isolated from the circled portion 1211. In the present aspect, when viewed in the first direction Z, the entirety of the circled portion 1211 overlaps the second inductor wire 22. The non-circled portion 1212 has an oblong shape extending in the lateral direction Y when viewed in the first direction Z, and is adjacent to the portion of the second inductor wire 22 where the sixth portion 226 and the seventh portion 227 are connected. The circled portion 1211 of the second body 121 and the protrusion 122 may be formed from the same component or different components.

An extended portion 165 is disposed at the middle of the non-circled portion 1212 in the lateral direction Y. The extended portion 165 extends from the non-circled portion 1212 in the longitudinal direction X away from the second axis A2. Of both end portions of the extended portion 165 in the longitudinal direction X, the distal end portion located farther from the non-circled portion 1212 is in contact with the magnetic member 201 of the element 2. The non-circled portion 1212 of the second body 121 and the extended portion 165 may be formed from the same component or different components.

The protrusion 122 is directed from the second body 121 toward the second axis A2 not by the shortest route but by deviating from the shortest route (or, by a longer route). When viewed in the first direction Z, the protrusion 122 does not extend from a connection portion 1223 connected to the second body 121 toward the end portion of the insulating layer 72 by the shortest distance D2. For example, the end portion of the insulating layer 72 is located at the boundary between the insulating layer 72 and the magnetic member 201 in the first area C1. The protrusion 122 has a dimension in which it extends longer than the shortest distance D2. In the present aspect, the protrusion 122 extends from the second body 121 in the direction crossing the second virtual straight line L2 passing the connection portion 1223 connected to the second body 121 and the second axis A2, and is then directed toward the second axis A2. In the present aspect, the protrusion 122 includes an extension portion 1221 and a bent portion 1222. The extension portion 1221 extends in the lateral direction Y away from the second center line CL2 from a portion of the second body 121 overlapping the first portion 221 of the inductor wire 22 when viewed in the first direction Z. The bent portion 1222 is bent toward the second axis A2 from an end portion, of both end portions of the extension portion 1221 in the lateral direction Y, located farther from the second center line CL2. More specifically, the second inductor wire 22 and the protrusion 122 form an angle other than a right angle.

As shown in FIG. 5, in the present aspect, of both end portions of the protrusion 122 in the direction in which the protrusion 122 extends, an end portion located farther from the second body 121 (specifically, an end portion, of both end portions of the bent portion 1222 in the direction in which the bent portion 1222 extends, located closer to the second axis A2) is in contact with the magnetic member 201 of the element 2 located in the first area C1 described below. Of both end portions of the protrusion 122 in the first direction Z, the end portion located closer to the second inductor wire 22 is in contact with an insulating layer 78. The insulating layer 78 is in contact with, of the side surfaces of the second inductor wire 22 crossing the second direction (for example, the longitudinal direction X), the second side surface 2201 located closer to the second axis A2 in the second direction (for example, the longitudinal direction X). The second body 121 and the protrusion 122 may be formed from the same component or different components.

As illustrated in FIG. 5, in the present aspect, the second conductor layer 12 includes five extended portions 161, 162, 163, 164, and 165.

The extended portion 161 extends in the second direction (for example, the lateral direction Y) toward the second axis A2 from a portion of the second body 121 overlapping the second portion 222 of the second inductor wire 22 when viewed in the first direction Z.

The extended portion 162 extends in the second direction (for example, the longitudinal direction X) toward the second axis A2 from a portion of the second body 121 overlapping the third portion 223 of the second inductor wire 22 when viewed in the first direction Z.

Of both end portions of the extended portion 161 in the lateral direction Y, a distal end portion located farther from the second body 121 is in contact with the magnetic member 201 located in the first area C1 described below. Of both end portions of the extended portion 162 in the longitudinal direction X, a distal end portion located farther from the second body 121 is in contact with the magnetic member 201 located in the first area C1.

The extended portion 163 extends in the second direction (for example, the longitudinal direction X) away from the second axis A2 from a portion of the circled portion 1211 overlapping the seventh portion 227 of the second inductor wire 22 when viewed in the first direction Z.

The extended portion 164 extends in the second direction (for example, the longitudinal direction X) away from the second axis A2 and in the direction opposite to the direction in which the extended portion 163 extends, from a portion of the circled portion 1211 overlapping the fifth portion 225 of the second inductor wire 22 when viewed in the first direction Z.

The extended portion 165 extends in the second direction (for example, the longitudinal direction X) away from the second axis A2, and in the direction the same as the direction in which the extended portion 163 extends, from the non-circled portion 1212 when viewed in the first direction Z.

Of both end portions of each of the extended portions 163 and 165 in the longitudinal direction X, a distal end portion located farther from the circled portion 1211 is exposed from the side surface 204 of the element 2. Of both end portions of the extended portion 164 in the longitudinal direction X, the distal end portion located farther from the circled portion 1211 is exposed from the side surface 205 of the element 2.

As illustrated in FIG. 5, the element 2 includes, inside, the first area C1 located closer to the second axis A2 than the second inductor wire 22, and the second area C2 located farther from the second axis A2 than the second inductor wire 22. In the present aspect, the first area C1 is surrounded by the first portion 221 to the fifth portion 225 of the second inductor wire 22 when viewed in the first direction Z. The magnetic member 201 and the non-magnetic member 203 are located in the first area C1. When viewed in the first direction Z, the magnetic member 201 in the first area C1 has a substantially rectangular shape, and is adjacent to the first portion 221 to the fourth portion 224. In other words, when viewed in the second direction from the second axis A2, the magnetic member 201 is adjacent to a portion including the largest number of portions of the second inductor wire 22. The non-magnetic member 203 in the first area C1 includes the insulating layer 78, and is adjacent to the magnetic member 201 in the first area C1, the first portion 221, the fourth portion 224, and the fifth portion 225 when viewed in the first direction Z. The magnetic member 201 is located over the entirety of the second area C2.

As illustrated in FIG. 5, the inductor component 1 includes a first pad portion 81 located on the second virtual plane S2. The first pad portion 81 is located to overlap the non-circled portion 1212 of the second conductor layer 12 when viewed in the first direction Z. A via 55 is connected to, of both end portions of the first pad portion 81 in the lateral direction Y, an end portion located closer to the second center line CL2.

As illustrated in FIG. 3, the inductor component 1 includes the insulating layer 71 and the insulating layer 72 (examples of first insulating layers) located inside the element 2. The insulating layer 71 is disposed on the opposite side of the first conductor layer 11 from the first inductor wire 21 in the first direction Z. The insulating layer 72 is disposed on the opposite side of the second conductor layer 12 from the second inductor wire 22 in the first direction Z. In other words, the insulating layer 72 is located between the first inductor wire 21 and the second conductor layer 12. The insulating layer 72 may be integrated with the insulating layer 73.

For example, the first conductor layer 11 has a thickness, serving as a dimension in the first direction Z, of less than 1.0 μm. The thickness of the first conductor layer 11 is less than 1/100 of the thickness of the first inductor wire 21. The second conductor layer 12 may also have the same structure as the first conductor layer 11. More specifically, the second conductor layer 12 may have a thickness of less than 1.0 μm and less than 1/100 of the thickness of the second inductor wire 22. Thus, the first conductor layer 11 is fully thinned for the first inductor wire 21, and the resistance of the first inductor wire 21 is dominant over the resistance of the first conductor layer 11. Thus, the selectivity of metal materials from which the first conductor layer 11 is formed improves. The first conductor layer 11 has a sufficiently thin thickness, and thus can reduce an inter-layer short-circuit through the first conductor layer 11. For example, when the first conductor layer 11 includes Ti/Cu layers deposited by sputtering, Ti has a thickness of 30 nm, and Cu has a thickness of 800 nm. The first conductor layer 11 can be formed by electroless plating or printing, instead of sputtering. The first conductor layer 11 can be formed from, for example, Au, Ag, or Al.

For example, each of the first conductor layer 11 and the second conductor layer 12 includes a single layer (Cu or Ag), or multiple layers (for example, Ti/Cu) laminated in the first direction Z. This structure can enhance the degree of freedom in designing the inductor component 1, and thus enables reduction of costs without losing the quality of the inductor component 1. For example, the number of layers included in each conductor layer may be set as appropriate. For example, when the first conductor layer 11 includes two layers (Ti/Cu) and the second conductor layer 12 includes one layer (Cu), the first conductor layer 11 can improve adhesion to a resin, and concurrently, the second conductor layer 12 can enhance adhesion to copper (a sacrificial copper portion).

In the present aspect, as illustrated in FIG. 3, the inductor component 1 includes an insulating layer 74 located inside the element 2. The insulating layer 74 is located farther from the second axis A2 than the magnetic member 201 in the second area C2 in the second direction, and is in contact with the magnetic member 201 in the second area C2 in the second direction. The insulating layer 74 has a greater thickness, or the dimension in the first direction Z, than the second inductor wire 22. In the present aspect, as illustrated in FIG. 1, the insulating layer 74 has a substantially belt shape extending around the second axis A2, and throughout the periphery of the element 2. The insulating layer 74 covers the second conductor layer 12 (for example, the second body 121). In other words, the insulating layer 74 is disposed not to allow the second inductor wire 22 and the second conductor layer 12 to be exposed to the outside of the inductor component 1 in the second direction. As illustrated in FIG. 3, the insulating layer 74 is in contact with, of both end portions of each of the extended portions 163, 164, and 165 of the second conductor layer 12, described later, in the first direction Z, an end portion located closer to the second inductor wire 22. For example, the insulating layer 74 extends in the first direction Z toward the main surface 202 from the second virtual plane S2.

For example, as illustrated in FIG. 4 and FIG. 5, portions of the four extended portions 154 of the first conductor layer 11 and the extended portions 163 and 165 of the second conductor layer 12 are located to overlap in the first direction Z, and the extended portion 153 of the first conductor layer 11 and the extended portion 164 of the second conductor layer 12 are located to overlap in the first direction Z. When viewed in the first direction Z, the insulating layer 74 has the same size as or a smaller size than the insulating layer 73, and the insulating layer 73 overlaps the entirety of the insulating layer 74. When the insulating layer 74 is greater than the insulating layer 73, an area (a gap) where no magnetic member 201 is disposed may be left when the magnetic members 201 in the second areas B2 and C2 are to be formed. In this case, the inductance obtaining efficiency of the inductor component 1 and the strength of the element 2 may be lowered. In contrast, with the above structure, the inductor component 1 can reduce the degradation of the inductance obtaining efficiency of the inductor component 1 or the strength of the element 2.

In the present aspect, as illustrated in FIG. 3, the inductor component 1 includes the outer terminal 101 disposed at the main surface 202, and the vertical wire 61 located inside the element 2. The vertical wire 61 extends in the first direction Z and is in contact with the magnetic member 201 of the element 2 in the second direction to connect the second inductor wire 22 and the outer terminal 101. In the present aspect, the vertical wire 61 is located not to overlap the first areas B1 and C1 and the second areas B2 and C2 when viewed in the first direction Z. Thus, while the magnetic member 201 is being filled, the vertical wire 61 bears no unnecessary force, and is thus less likely to be broken. The vertical wire 61 is in contact with the magnetic member 201 in the second direction, and thus the magnetic member 201 can increase its volume, and the inductor component 1 can improve its inductance obtaining efficiency. The vertical wire 61 is used to be connected to the outer terminal 101, and thus can ensure the insulating properties without having an insulating layer. This structure eliminates a process of forming an insulating layer at the vertical wire 61, and thus can reduce the manufacturing cost of the inductor component 1. The vertical wire 61 may be directly connected to the second inductor wire 22, instead of using the via 53. Alternatively, the vertical wire 61 may be connected to the second inductor wire 22 using, in addition to the via 53, a seed layer or a layer used for forming the vertical wire 61.

The insulating layers (for example, the insulating layers 71, 72, and 75) that are in contact with both end portions of the first inductor wire 21 and the second inductor wire 22 in the first direction Z and the insulating layers (for example, the insulating layers 73, 74, 77, and 78) that are in contact with both end portions of the first inductor wire 21 and the second inductor wire 22 in the second direction are formed from, for example, different materials. For example, the insulating layers 71, 72, and 75 are formed from an insulating material including epoxy-based and an inorganic filler, and the insulating layers 73, 74, 77, and 78 are formed from an acrylic insulating material.

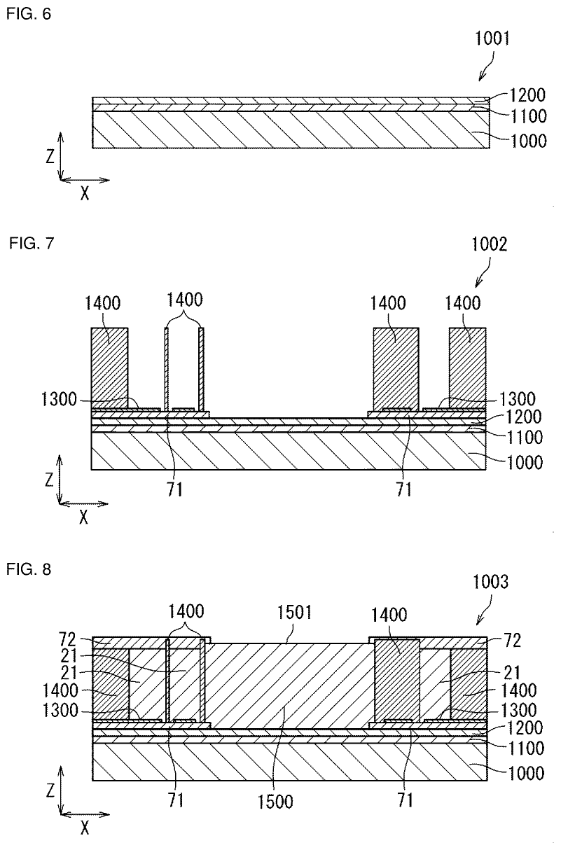

With reference to FIG. 6 to FIG. 15, an example of a method for manufacturing the inductor component 1 is described. FIG. 6 to FIG. 15 correspond to cross sections taken along line III-III in FIG. 2. In the manufacturing method illustrated in FIG. 6 to FIG. 15, at least one or all of the processes are automatically performed using, for example, a device for manufacturing the inductor component 1.

As illustrated in FIG. 6 and FIG. 7, the manufacturing device forms the insulating layer 71 in a first multilayer body 1001 obtained by laminating an adhesive layer 1100 and a seed layer (conductor) 1200 on a substrate 1000, and then forms a pattern seed 1300 over the insulating layer 71 and the seed layer 1200, and a permanent resist 1400 to form a second multilayer body 1002. The pattern seed 1300 serves as the first conductor layer 11. The insulating layer 71 is formed by a process involving, for example, lamination of insulating layers, and photolithography, and curing. The pattern seed 1300 is formed by a process involving, for example, sputtering (forming seed), resist lamination, photolithography, seed etching, and resist separation. The permanent resist 1400 is formed by a process involving, for example, permanent resist lamination, photolithography, and curing. A part of the permanent resist 1400 serves as the non-magnetic member 203 and the insulating layer 73.

As illustrated in FIG. 8, the manufacturing device concurrently forms the first inductor wire 21 and a sacrificial copper portion 1500 in the second multilayer body 1002, and then forms the insulating layer 72 at the first inductor wire 21. The first inductor wire 21 and the sacrificial copper portion 1500 are formed by a process involving, for example, electrolytic plating (for example, electric field copper plating). The insulating layer 72 is formed by a process involving, for example, insulating layer lamination, photolithography, and curing. In this case, during photolithography, a magnetic path cavity 1501 and the vias 51 and 52 are concurrently formed.

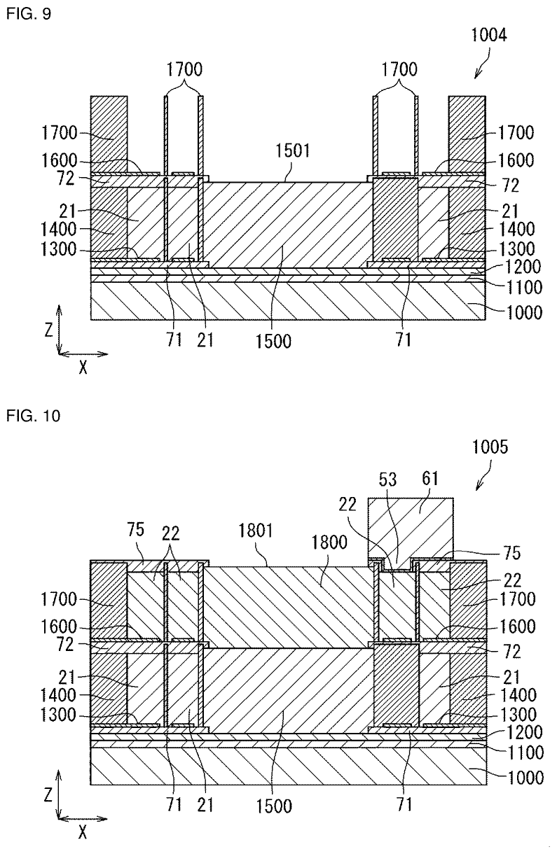

As illustrated in FIG. 9, the manufacturing device forms a pattern seed 1600 located at the insulating layer 72 and a permanent resist 1700 in a third multilayer body 1003 to form a fourth multilayer body 1004. The pattern seed 1600 serves as the second conductor layer 12. The pattern seed 1600 is formed by a process involving, for example, sputtering (forming seed), resist lamination, photolithography, seed etching, and resist separation. The permanent resist 1700 is formed by a process involving permanent resist lamination, photolithography, and curing. A part of the permanent resist 1700 serves as the insulating layer 74.

The pattern seed 1600 may be formed from the same material as the pattern seed 1300 of the second multilayer body 1002 or a different material from the pattern seed 1300. The pattern seeds 1300 and 1600 are formed from an optimum material selected for the corresponding layers. For example, when the pattern seed 1300 for the first layer is formed from an electroconductive material including Ti, the adhesion to the insulating layer 71 and the seed layer 1200 can be improved. When the pattern seed 1600 for the second layer is formed from the same electroconductive material (for example, only Cu) as the second inductor wire 22, connectivity with the vias 53 and 54 can be improved.

As illustrated in FIG. 10, after concurrently forming the second inductor wire 22 and a sacrificial copper portion 1800 in the fourth multilayer body 1004, the manufacturing device forms the insulating layer 75 at the second inductor wire 22, and forms the vertical wire 61 at the insulating layer 75 to form a fifth multilayer body 1005. The second inductor wire 22 and the sacrificial copper portion 1800 are formed by a process involving, for example, electrolytic plating (for example, electric-field copper plating). The insulating layer 75 is formed by a process involving insulating-layer lamination, photolithography, and curing. In this case, during photolithography, a magnetic path cavity 1801 and the vias 53 and 54 are concurrently formed. The vertical wire 61 is formed by a process involving, for example, sputtering (forming seed over the entire surface), resist lamination, photolithography, electrolytic plating, resist separation, and seed etching.

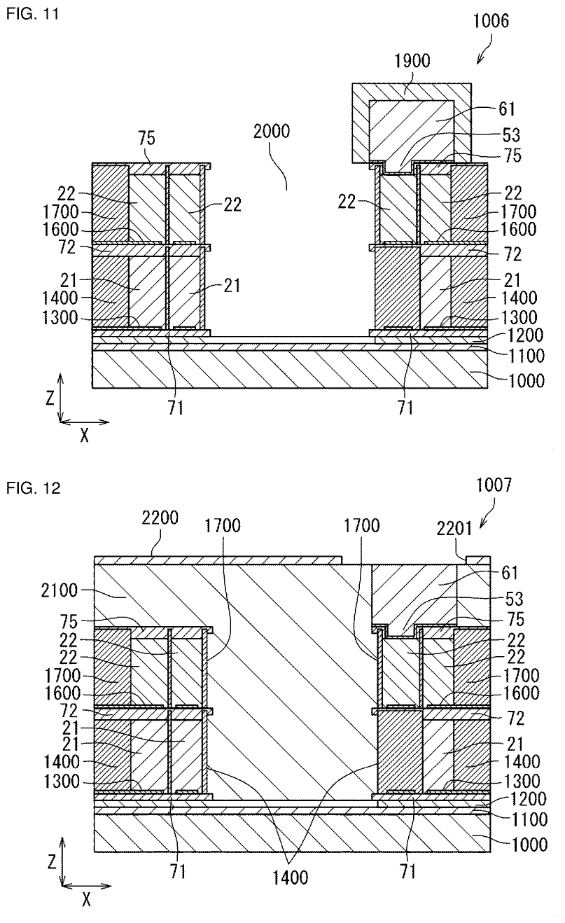

As illustrated in FIG. 11, after forming a protective layer 1900 at the vertical wire 61, the manufacturing device removes the sacrificial copper portions 1500 and 1800 from the fifth multilayer body 1005, and forms a magnetic path hole 2000 to thus form a sixth multilayer body 1006. The protective layer 1900 is formed by a process involving, for example, resist lamination and photolithography. The sacrificial copper portions 1500 and 1800 are removed by, for example, etching. When the pattern seed 1300 for the first layer includes Ti, Ti etching is performed after Cu etching, and a part of the seed layer 1200 is left.

As illustrated in FIG. 12, after removing the protective layer 1900 in the sixth multilayer body 1006, the manufacturing device forms a magnetic layer 2100, and forms a solder resist (an insulating layer) 2200 at the magnetic layer 2100 to form a seventh multilayer body 1007. The protective layer 1900 is removed by a process involving, for example, resist separation. The magnetic layer 2100 is formed by a process involving, for example, magnetic member pressing, curing, and grinding. The vertical wire 61 is exposed to the outside by grinding. The magnetic layer 2100 serves as a part of the magnetic member 201. The solder resist 2200 is formed by a process involving, for example, solder-resist lamination, photolithography, and curing. A cavity 2201 that exposes the vertical wire 61 to the outside is formed in the solder resist 2200. The solder resist 2200 serves as the insulating layer 76.

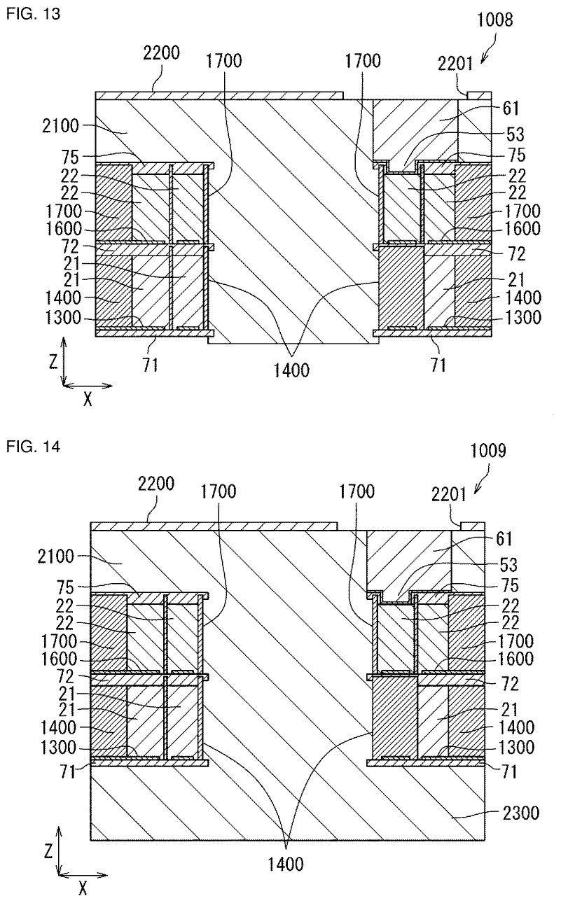

As illustrated in FIG. 13, the manufacturing device removes the substrate 1000, the adhesive layer 1100, and the seed layer 1200 from the seventh multilayer body 1007 to form an eighth multilayer body 1008. The substrate 1000 and the adhesive layer 1100 are removed by, for example, mechanically detaching the adhesive layer 1100. The seed layer 1200 is removed by, for example, wet etching or grinding. To remove the seed layer 1200 by wet etching, a part of the magnetic metal powder of the magnetic layer 2100 is etched, and thus its surface is roughened. This structure improves adhesion to a magnetic layer 2300 formed in the subsequent process.

As illustrated in FIG. 14, the manufacturing device forms the magnetic layer 2300 in the eighth multilayer body 1008 to form a ninth multilayer body 1009. The magnetic layer 2300 is formed by a process involving, for example, magnetic-member pressing, curing, and grinding. Grinding is performed to adjust the thickness of the element 2. The thickness of the element 2 may be adjusted by adjusting the amount of pressing during forming the magnetic layer 2300 without grinding. The magnetic layer 2300 serves as a part of the magnetic member 201.

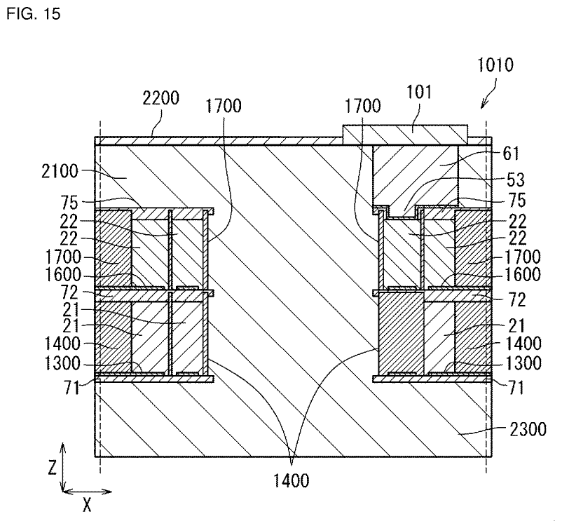

As illustrated in FIG. 15, after forming an outer terminal 101 in the ninth multilayer body 1009 to form a tenth multilayer body 1010, the manufacturing device may cut the tenth multilayer body 1010 into pieces to form the inductor component 1 illustrated in FIG. 3. The outer terminal 101 is formed by a process involving, for example, sputtering (Cu seed), resist lamination, photolithography, electrolytic plating, resist separation, and seed etching. The tenth multilayer body 1010 is cut into pieces along, for example, broken lines in FIG. 15.

Instead of forming the outer terminal 101, the vertical wire 61 exposed to the outside may serve as an outer terminal. As in the present aspect, when a structure where the outer terminal 101 is formed in the cavity 2201 of the solder resist 2200 and connected to the vertical wire 61 is employed, the area of the outer terminal 101 can be increased, and thus, the adhesion of the inductor component 1 to, for example, another device can be improved. In addition, the outer terminal 101 with any shape such as a convex shape may be formed. Thus, the degree of freedom for installing the inductor component 1 is improved.

The outer terminal 101 may be formed without forming the solder resist 2200. As in the case of the vertical wire 61, the outer terminal 101 may be formed by, for example, forming a seed layer over the entire surface, and electrolytic plating. In this case, the outer terminal 101 has a structure like a Cu bump.

The inductor component 1 can exert effects below.

The inductor component 1 includes the first inductor wire 21 extending around the first axis A1 in the first direction Z, and the element 2 in which the first inductor wire 21 is located. The element 2 includes the magnetic member 201 spaced farther from the first axis A1 than the first inductor wire 21 in the second direction, and the insulating layer 73 (an example of a first protective film) spaced farther from the first axis A1 than the magnetic member 201 in the second direction and in contact with the magnetic member 201 in the second direction. The insulating layer 73 has a greater thickness than the first inductor wire 21. This structure can reduce the degradation of the inductance obtaining efficiency. This structure can thus reduce the deterioration of the magnetic member 201.

For example, an inductor component having an electrode disposed at the bottom surface does not involve the use of solder fillet at its side surface. Thus, to install multiple inductor components, adjacent inductor components are arranged with a narrow distance interposed therebetween. In a state where a magnetic member containing magnetic metal powder is exposed to the side surface of each inductor component to be installed, when adjacent inductor components move closer to each other, they may be short-circuited with magnetic metal powder detached due to environmental stress (for example, humidity or heat), or the magnetic metal powder rusts, and thus the inductor component may lower the inductance obtaining efficiency. The inductor component 1 includes the insulating layer 73, and thus can reduce the degradation of the inductance obtaining efficiency.

The inductor component 1 includes the first conductor layer 11 located on the first virtual plane S1 crossing the first direction Z. The first inductor wire 21 is disposed on the first conductor layer 11. The first conductor layer 11 includes the first body 111 located around the first axis A1, and the extended portions 151, 153, and 154 extending from the first body 111 in the second direction away from the first axis A1, or in the second direction toward the first axis A1. With this structure, for example, when the first inductor wire 21 is formed by electrolytic plating with the first conductor layer 11, the distance between portions of the first inductor wire 21 adjacent in the second direction can be reduced. Thus, the density of the first inductor wire 21 can be increased, and the direct-current electrical resistance of the inductor component 1 can be reduced.

The inductor component 1 includes the second conductor layer 12 located on the second virtual plane S2 parallel to and adjacent to the first virtual plane S1, and the second inductor wire 22 disposed on the second conductor layer 12. The second inductor wire 22 is located on the opposite side of the second conductor layer 12 from the first conductor layer 11 in the first direction Z, and extends around the second axis A2 extending in the first direction Z. With this structure, the total number of turns of the inductor wire of the inductor component 1 is increased, and thus, the inductor component 1 can enhance the inductance obtaining efficiency. The first inductor wire 21 and the second inductor wire 22 are laminated in the same direction, and thus, for example, the inductor component 1 in which three or more inductor wires including the first inductor wire 21 and the second inductor wire 22 are laminated can be easily implemented.

The insulating layer 73 covers the first conductor layer 11. This structure can protect the first conductor layer 11 from the environmental stress.

The insulating layer 73 includes multiple materials, which at least include an inorganic filler. The insulating layer 73 including multiple materials improves the degree of freedom in designing the inductor component 1. The multiple materials including an inorganic filler can easily lower the coefficient of linear expansion of the insulating layer 73, and reduce residual stress. Thus, crack resistance to, for example, thermal stress can be imparted to the insulating layer 73. In addition, the inorganic filler can provide the insulating layer 73 with preferable insulating properties.

The insulating layer 73 includes multiple materials, all of which are photosensitive materials. The insulating layer 73 includes multiple materials, and thus, the degree of freedom in designing the inductor component 1 improves. All the multiple materials are photosensitive materials, and thus, the insulating layer 73 can be concurrently formed when the first inductor wire 21 and the vias 51 and 52 are formed. Thus, the manufacturing cost for the inductor component 1 can be reduced while the properties of the insulating layer 73 for protecting the element 2 are reliably enhanced.

The inductor component 1 includes the insulating layer 72 (an example of a first insulating layer) disposed inside the element 2, and located between the first inductor wire 21 and the second conductor layer 12. The insulating layer 72 and the insulating layer 73 are formed into an integrated unit. This structure can reduce the cost for manufacturing the inductor component 1. In addition, the protective film thicker than the first inductor wire 21 can be easily formed, and thus the properties of protection from the environmental stress can be easily enhanced.

The inductor component 1 includes the insulating layer 76 (an example of a second protective film) that is in contact with one of both end portions of the element 2 in the first direction Z (for example, the main surface 202). The surface of the element 2 suffers stress (damages from alkali) after undergoing a process such as electroless plating while the outer terminals 101, 102, and 103 are formed. Thus, providing the insulating layer 76 can reduce stress that the element 2 suffers attributable to the process of manufacturing the inductor component 1. When the insulating layer 76 is formed from a material appropriate for the process of manufacturing the inductor component 1, the reliability and the yield of the inductor component 1 can be enhanced. For example, forming the insulating layer 73 concurrently with the first inductor wire 21 requires patterning with a high aspect and high transparency. Thus, a selectable range of materials to form the insulating layer 73 includes a photosensitive polyimide-based material. In contrast, a relatively rough pattern such as the outer terminals 101, 102, and 103 is formed for the insulating layer 76. When the outer terminals 101, 102, and 103 are to be formed through the process of electroless plating, the selectable range of materials to form the insulating layer 76 includes an epoxy-based material for printing containing a pigment and an inorganic filler in consideration of shielding properties of the element 2. Thus, the materials of the insulating layers 73 and 76 are selected in accordance with the design of the inductor component 1.

The inductor component 1 can be formed in the following manner.

The element 2 is not limited to have a structure in which the insulating layers 71 and 72 are in contact with the end portion of the insulating layer 73 (an example of the first protective film) in the first direction Z. For example, the element 2 may have a structure in which the magnetic member 201 is in contact with the end portion of the insulating layer 73 in the first direction Z. In this structure, the volume of the magnetic member 201 increases, and thus, the inductance obtaining efficiency of the inductor component 1 can be enhanced. As in the insulating layer 74, the insulating layer 73 may have only one end in the first direction Z in contact with the magnetic member 201 (refer to FIG. 1), or may have both ends in the first direction Z in contact with the magnetic member 201.

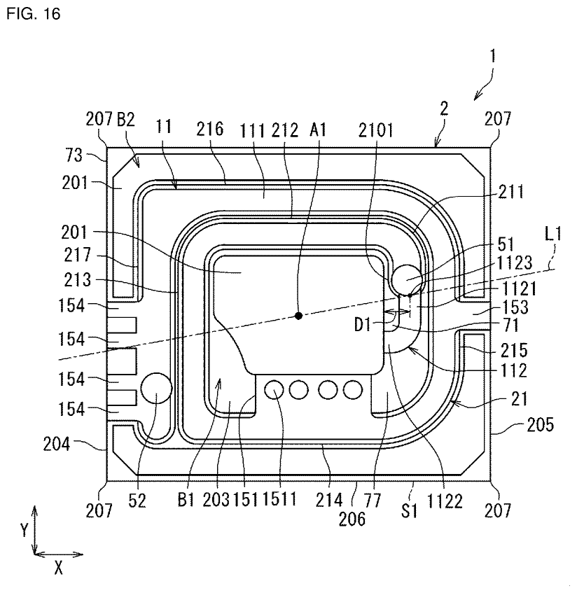

As illustrated in FIG. 16, in the insulating layer 73 in the element 2, the width of the insulating layer 73 may be greatest at corners 207. In the inductor component 1 illustrated in FIG. 16, the element 2 has a rectangular shape when viewed in the first direction Z. Each corner 207 of the magnetic member 201 is chamfered. When viewed in the first direction Z, the dimension of the minimum distance from the outer surface of the insulating layer 73 to the magnetic member 201 is referred to as “a width of the insulating layer 73”. The corners 207 of the element 2 are subject to chipping. Thus, the insulating layer 73 that is more flexible than the magnetic member 201 is provided to the corners 207 of the magnetic member 201 to reduce chipping. In the inductor component 1 illustrated in FIG. 16, the insulating layer 73 is disposed over the entirety of the side surface of the element 2, but is not limited thereto. For example, the insulating layer 73 may be disposed at only the corners 207 of the element 2.

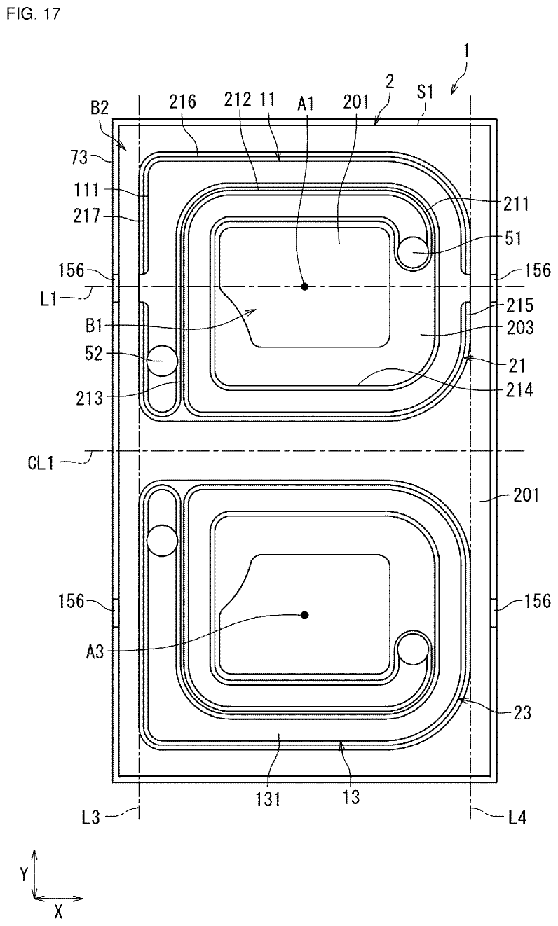

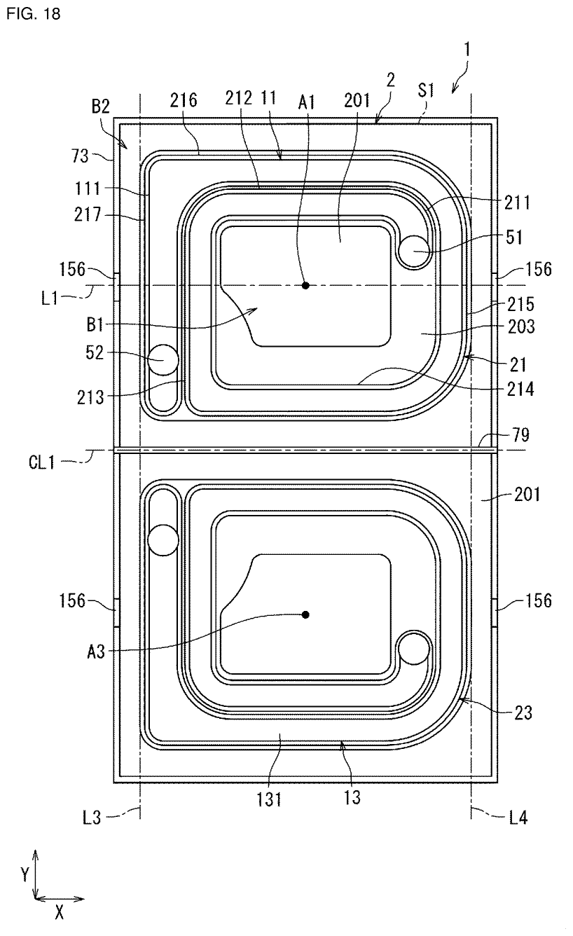

As illustrated in FIG. 17 and FIG. 18, portions 156 of the first conductor layer 11 that are in contact with the insulating layer 73 may be spaced apart from the first inductor wire 21. Specifically, the portions 156 of the first conductor layer 11 that are in contact with the insulating layer 73 and the first inductor wire 21 may be in no contact with each other, and may thus be electrically insulated from each other. This structure can protect the first inductor wire 21 even when the first conductor layer 11 is corroded by the environmental stress, and thus, an increase of the direct-current electrical resistance of the inductor component 1 can be reduced.

The inductor component 1 illustrated in FIG. 17 and FIG. 18 includes a third conductor layer 13 located on the first virtual plane S, a third inductor wire 23, and an insulating layer 79 (an example of a second insulating layer). The third conductor layer 13 is located to be symmetric with the first conductor layer 11 with respect to the first center line CL1 extending in the lateral direction (for example, an X direction) of the inductor component 1 on the first virtual plane S1 when viewed in the first direction Z, and has a shape that is symmetric with the first conductor layer 11 with respect to the first center line CL1. The third inductor wire 23 is located to be symmetric with the first inductor wire 21 with respect to the first center line CL1, and has a shape that is symmetric with the first inductor wire 21 with respect to the first center line CL1. The third inductor wire 23 is located around the third axis A3 located symmetric with the first axis A1 with respect to the first center line CL1. The insulating layer 79 is located between the first inductor wire 21 and the third inductor wire 23 in the second direction (for example, the Y direction). For example, the insulating layer 79 extends along the first center line CL1. The insulating layer 73 and the insulating layer 79 are formed into an integrated unit. When multiple inductor wires are arranged on the same virtual plane, the mount area density can be improved. In addition, the insulating layer 79 insulates the first inductor wire 21 and the third inductor wire 23 from each other, and thus, the inductor component 1 with high reliability can be implemented while having an increased mount area density.

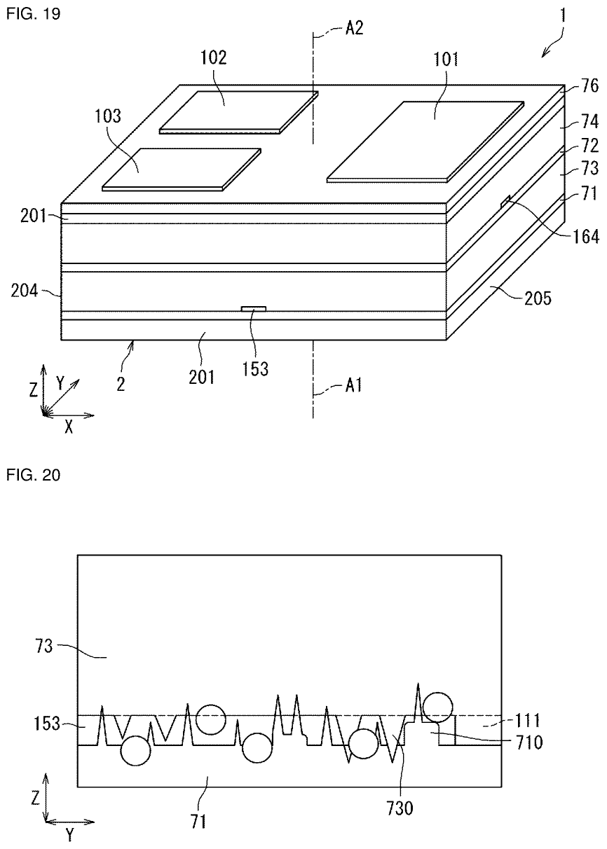

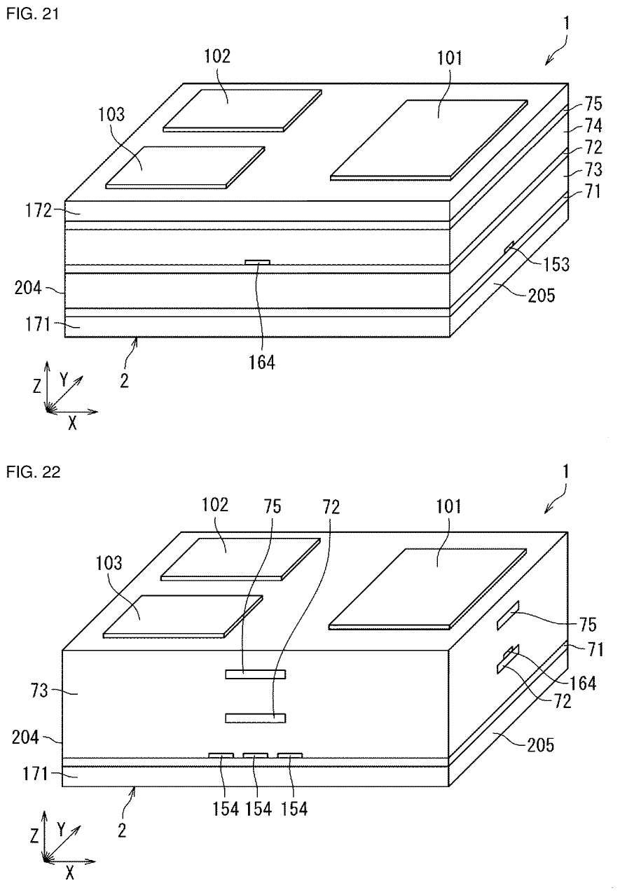

The positions of the extended portions 153 and 154 of the first conductor layer 11 and the positions of the extended portions 163, 164, and 165 of the second conductor layer 12 may be set as appropriate. For example, in the inductor component 1 illustrated in FIG. 19, the extended portion 164 of the second conductor layer 12 is exposed from the side surface 205 of the element 2, and the extended portions 153 of the first conductor layer 11 is exposed from a side surface crossing the side surfaces 204 and 205 of the element 2. In the inductor component 1 illustrated in FIG. 21, the extended portions 153 of the first conductor layer 11 is exposed from the side surface 205 of the element 2, and the extended portion 164 of the second conductor layer 12 is exposed from a side surface crossing the side surfaces 204 and 205 of the element 2.

The inductor component 1 may have a structure where the distal end portion of each of the extended portions 153 154, 163, 164, and 165 exposed from the side surfaces 204 and 205 of the element 2 is in contact with at least one insulating layer. This structure can improve the corrosion resistance of the first conductor layer 11.

FIG. 20 illustrates an example of a distal end portion of the extended portion 153. In FIG. 20, the distal end portion of the extended portion 153 is in contact with the insulating layer 71 and the insulating layer 73. For example, during cutting into pieces (refer to FIG. 15), the side surfaces 204 and 205 are formed by down-cutting or up-cutting (cutting while rotating the blade in the first direction Z), the insulating layers (for example, the insulating layers 71, 72, 73, and 74) located around the extended portions 153, 154, 163, 164, and 165 are extended, and thus, the distal end portions of the extended portions 153, 154, 163, 164, and 165 are covered. Thus, the extended portions 153, 154, 163, 164, and 165 each having the distal end portion in contact with at least one insulating layer are obtained.

The inductor component 1 may have a structure where the insulating layer 73 covers the entireties of the distal end portions of the extended portions 153 and 154. This structure can further improve the corrosion resistance of the first conductor layer 11. When the distal end portions of the extended portions 153 and 154 are covered with an insulation filler such as silica included in the first insulating layer 71 or the third insulating layer 73, the properties such as the inter-layer short-circuit resistance are further improved.

The inductor component 1 may include a third protective film having a lower ratio of exposure to the outside than the insulating layer 73 at the side surface of the element 2 in the first direction Z. In this structure, the interface between the insulating layer 73 and the third protective film is reduced at the side surface of the element 2 in the first direction Z, and thus the properties of protecting the magnetic member 201 can be further improved. The exposure ratio of the insulating layer 73 or the third protective film indicates the ratio of the area exposed to the outside to the entire surface area of the insulating layer 73 or the third protective film.

The inductor component 1 illustrated in FIG. 21 includes, as third protective films, the insulating layers 71, 72, and 75 and insulating layers 171 and 172. For example, the insulating layer 171 covers the entirety of the side surface of the magnetic member 201 extending in the first direction Z, located farther from the main surface 202 than the insulating layer 71 in the first direction Z. The insulating layer 172 covers the entire side surfaces of the magnetic member 201 and the insulating layer 76 extending in the first direction Z, located between the insulating layer 75 and the main surface 202 in the first direction Z. The inductor component 1 illustrated in FIG. 21 can be formed by, for example, the method as below.

After the vertical wire 61 is formed (refer to FIG. 10 and FIG. 11), a permanent resist is formed in an area serving as a side surface of the element 2 extending in the first direction Z. After the base substrate 1000 is removed, a permanent resist is formed on the surface opposite to the surface at which the inductor wire is formed.

The inductor component 1 illustrated in FIG. 22 includes, as third protective films, the insulating layers 71, 72, and 75 and the insulating layer 171. The insulating layers 72 and 75 are only partially exposed from the side surface of the element 2 extending in the first direction Z. In the inductor component 1 illustrated in FIG. 22, the insulating layer 73 covers a portion of the side surface of the element 2 extending in the first direction Z, excluding a portion from which the third protective films are exposed. In the inductor component 1 illustrated in FIG. 22, the first conductor layer 11 includes three extended portions 154. In the inductor component 1 illustrated in FIG. 22, for example, via holes are formed at portions of the insulating layer 73 corresponding to the third protective films, and the insulating layers 72 and 75 are formed in these via holes.

The inductor component 1 may include conductor layers located on three or more virtual planes parallel to one another, and inductor wires disposed at these conductor layers. More specifically, the inductor component 1 may include three or more layers of inductor wires.

The inductor component 1 may have a structure where only the first conductor layer 11 is located on the first virtual plane S1, or a structure where two or more conductor layers including the first conductor layer 11 are located on the first virtual plane S1. Similarly, the inductor component 1 may have a structure where only the second conductor layer 12 is located on the second virtual plane S2, or a structure where two or more conductor layers including the second conductor layer 12 are located on the second virtual plane S2. Specifically, the inductor component 1 in which electrically isolated multiple inductor wires are disposed on the same virtual plane can be implemented.

Any of the conductor layers (for example, the first conductor layer 11 and the second conductor layer 12), the insulating layers (for example, the insulating layer 71, the insulating layer 72, the insulating layer 74, and the insulating layer 76), the vertical wire 61, and the vias 51, 52, 53, 54, and 55 located inside the element 2 may be omitted in accordance with, for example, the design of the inductor component 1.

The shape and the size of each portion included in the inductor component 1 are not limited to the above aspects, and may be set as appropriate in accordance with, for example, the design of the inductor component 1. For example, the thickness of the first conductor layer 11 of the inductor component 1 is not limited to be less than 1.0 μm and less than 1/100 of the thickness of the first inductor wire.

Each inductor wire may have any shape that is spiral when viewed in the first direction Z. For example, each inductor wire may be a curve having one or more turns, or having fewer than one turn. Each inductor wire may have a partially straight shape.

Of the embodiments of the present disclosure and the modification examples, any two or more of the embodiments may be combined, any two or more of the modification examples may be combined, or at least one of the embodiments and at least one of the modification examples may be combined. Instead, any two or more features included in the embodiments of the present disclosure and the modification examples may be combined.

The present disclosure is naturally changeable in terms of the details of the components, and combinations of elements in the embodiments or sequential changes can be implemented without deviating from the claimed scope and the gist of the present disclosure.

What is claimed is:

1. An inductor component, comprising:
a first inductor wire that extends around a first axis extending in a first direction; and
an element including the first inductor wire,
wherein
the element includes
a magnetic member that is spaced farther from the first axis than the first inductor wire in a second direction that crosses the first direction, and
a first protective film that is spaced farther from the first axis than the magnetic member in the second direction, and that is in contact with the magnetic member in the second direction, and
the first protective film has a thickness, serving as a dimension in the first direction, greater than the thickness of the first inductor wire.

2. The inductor component according to claim 1, further comprising:
a first conductor layer located on a first virtual plane that crosses the first direction,
wherein
the first inductor wire is on the first conductor layer, and
the first conductor layer includes
a first body located around the first axis, and
an extended portion extending from the first body in the second direction away from the first axis or in the second direction toward the first axis.

3. The inductor component according to claim 2, further comprising:
a second conductor layer located on a second virtual plane parallel to and adjacent to the first virtual plane; and
a second inductor wire disposed on the second conductor layer, located on an opposite side of the second conductor layer from the first conductor layer in the first direction, and extending around a second axis extending in the first direction.

4. The inductor component according to claim 2, wherein
the first protective film covers the first conductor layer.

5. The inductor component according to claim 1, wherein
the first protective film includes a plurality of materials, and
the plurality of materials include at least an inorganic filler.

6. The inductor component according to claim 1, wherein
the first protective film includes a plurality of materials, and
all the plurality of materials are photosensitive materials.

7. The inductor component according to claim 3, further comprising:
a first insulating layer disposed in the element, and located between the first inductor wire and the second conductor layer,
wherein the first protective film and the first insulating layer are configured as an integrated unit.

8. The inductor component according to claim 1, wherein
the element has a structure in which the magnetic member is in contact with an end portion of the first protective film in the first direction.

9. The inductor component according to claim 1, wherein
the magnetic member has a rectangular shape having a chamfered corner when viewed in the first direction, and
when a dimension in a direction in which a distance from an outer surface of the first protective film to the magnetic member is minimum when viewed in the first direction is defined as a width, the width of the first protective film is greatest at the chamfered corner.

10. The inductor component according to claim 4, wherein
a portion of the first conductor layer that is in contact with the first protective film is spaced apart from the first inductor wire.

11. The inductor component according to claim 2, further comprising:
a third conductor layer located on the first virtual plane;
a third inductor wire disposed at the third conductor layer, and located around a third axis extending in the first direction and spaced apart from the first axis in the second direction; and
a second insulating layer between the first inductor wire and the third inductor wire in the second direction,
wherein the first protective film and the second insulating layer are configured as an integrated unit.

12. The inductor component according to claim 2, wherein
the extended portion extends from the first body in the second direction away from the first axis, and
of two end portions of the extended portion in the second direction, a distal end portion that is farther from the first body is in contact with the first protective film.

13. The inductor component according to claim 12, wherein
the first protective film covers an entirety of the distal end portion.

14. The inductor component according to claim 1, further comprising:
a second protective film that is in contact with one of two end portions of the element in the first direction.

15. The inductor component according to claim 1, further comprising:
a third protective film at a side surface of the element extending in the first direction, and having a lower ratio of exposure to an outside than the first protective film.

16. The inductor component according to claim 3, wherein
the first protective film covers the first conductor layer.

17. The inductor component according to claim 2, wherein
the first protective film includes a plurality of materials, and
the plurality of materials include at least an inorganic filler.

18. The inductor component according to claim 2, wherein
the first protective film includes a plurality of materials, and
all the plurality of materials are photosensitive materials.

19. The inductor component according to claim 2, wherein
the element has a structure in which the magnetic member is in contact with an end portion of the first protective film in the first direction.

20. The inductor component according to claim 2, wherein
the magnetic member has a rectangular shape having a chamfered corner when viewed in the first direction, and
when a dimension in a direction in which a distance from an outer surface of the first protective film to the magnetic member is minimum when viewed in the first direction is defined as a width, the width of the first protective film is greatest at the chamfered corner.
